(19) United States
(12) Patent Application Publication
(10) Pub. No.: US 2009/0053485 A1
(43) Pub. Date: Feb. 26, 2009

(54) Surface Decoration System

(76) Inventor: Melanie Royals, National City, CA (US)

Correspondence Address: LAW OFFICE OF MARK WISNOSKY, 3060 6TH AVE., # 8, SAN DIEGO, CA, 92103, US

(21) Appl. No.: 11/844,893

(22) Filed: Aug. 24, 2007

(51) Int. Cl. B32B 3/10; B05C 21/00

(52) U.S. Cl. 428/201; 118/46; 427/282

(57) ABSTRACT

A surface decoration system is described. The system includes materials and processes that enable detailed multiple color and hue patterns to be placed upon a surface without the need for abilities to paint fine detail. Successive coating layers are applied with a broad-brush applicator. The process may be used for colors, gray scale, stain and any other optical effect that may be effected through sequential application of coatings. An example shows application of the technique to a faux marquetry flooring design.

### TECHNICAL FIELD

Embodiments of the invention relate to a system that enables the decoration of surfaces. A particular example is creation of faux marquetry products.

### BACKGROUND OF THE INVENTION

Decorating surfaces with paint, stains or other colorations has existed for centuries. Advanced technology such as optical lithography and various printing techniques has made detailed decorations readily available. However custom designs remain in the realm of the artisan. The ability to color or otherwise decorate surface with a personally chosen pattern or motif is still difficult to accomplish without significant skills. The ability to decorate large expanses, such as walls, floors and ceiling with custom designed and selected motifs remains difficult and expensive.

Another decorating art form, Marquetry, dates from the 16^{th} century. A variety of personal and furniture items such as wooden boxes, tables, cabinetry have been decorated through an inlay process in which decorative patterns and pictures are produced on a surface by cutting and inlaying pieces of different colored wood veneers. Other forms of the art also use stones, mother of pearl and other such materials that can provide contrasting colors to produce patterns and images. Marquetry is generally limited to small personal items due to the artisan skill required to produce the pieces and the time and expense. Application of the technique to larger areas such as floors or other structural elements would be limited to government buildings and the homes of the very wealthy. Today marquetry is still practiced by woodworking artisans using much the same techniques as their 16^{th} century counterparts. The improvements have come only through addition of better tools and power tools. Application to large areas such as floors is still very rare.

There have been attempts to mimic the effect obtained from marquetry by painting or staining patterns into wood or other materials. The result of such attempts is often termed faux marquetry. Stencils are often used in conjunction with multiple colors of paint, stain or varnish to better produce more complicated designs. Multiple colors are used in conjunction with stencils either by using multiple stencils with different areas cut out for application of the paint or varnish. As more colors are added to a pattern the skill required to obtain satisfactory results increases. One way to apply multiple colors it to use multiple sets of stencils. Some techniques would use one stencil with each color. If multiple stencils are used either each stencil is removed after applying a corresponding color or multiple stencils are stacked one upon the other. Either case requires careful registration of the second stencil with either the first stencil or with the partially complete pattern. There is also a requirement to wait for the previously applied partial pattern to dry before applying the stencil for the next color over the top. There are also techniques for using a single stencil to apply multiple colors. The stencil is applied to the base and the multiple colors are carefully applied the different openings intended for each color. Detailed patterns may require as fine a hand and skill as simply free painting the pattern on the surface. Alternatively the various sections of the single stencil may be scored, but not removed until that section's “turn” comes up for application of the paint or stain. Again closely spaced colors and detail will require exceptional painting skill on the part of the person applying the pattern.

A method is needed that can apply finely detailed multiply colored designs onto wood or other surfaces. The method should be applicable using a single stencil to avoid registration problems. A method is needed that does not require increased painting skills as more closely spaced or finely detailed patterns are used. A method is needed that is applicable to large areas such as floors as well as smaller areas such as personal items and furniture.

### SUMMARY OF THE INVENTION

A system of producing faux marquetry and other design patterns that addresses many of the drawbacks of the current art is presented. The system takes advantage of the additive color effect of applying different shades of wood stain or other colorants one atop the other. The final color in any particular region of the designs is the result of a “summation” of the effect of the multiply applied layers. An area to be decorated is cleaned and made ready to accept stains or other colorants. Requirements for the colorants include that they are compatible for coloration of the surface of interest and multiple colorants may be applied one atop the other to produce a combined color as the “sum” of the two added colors. In one embodiment wood stains are used as colorants. The wood stains provide a transparent coloration that allows an effect of the first applied stain to show through and affect the coloration of the last applied stain layer. The end color is affected by the selection of colorant s and the order of application. Another embodiment uses any colorant whose visible effect on coloration of a surface can result from the summation of the effect of multiple layers.

Another embodiment provides a technique to define the order of application of multiple colorants to produce a desired end effect.

Other embodiments provide stencils and methods to design and produce stencils consistent with the system.

The system does not require the ability to paint fine detail. The stencil provides the detail. Each color is applied in a broad swath across the entire area to be decorated. Sections of the stencil are removed between applications of the different colors. The system includes the tools, methods to produce the tools, methods to use the tools and the finished products.

### BRIEF DESCRIPTION OF THE DRAWINGS

In order that this invention can be more readily understood, reference will now be made by way of example to the accompanying drawings.

FIG. 1 is a diagram of a stencil embodiment of the invention.

FIG. 2 is a block diagram of a colorant application method consistent with embodiments of the invention.

FIG. 3 is a block diagram of a stencil design method consistent with embodiments of the invention.

FIG. 4 is a diagram of an embodiment of the invention having 6 colorant levels.

FIG. 5 is a diagram of a stencil consistent with the embodiment of FIG. 4.

FIG. 6 is a diagram demonstrating a colorant application step embodiment of the invention.

FIG. 7 is a diagram demonstrating a stencil application step embodiment of the invention.

FIG. 8 is a diagram demonstrating a later progression than FIG. 7 stencil application step embodiment of the invention.

FIG. 9 is a photograph of a finished article consistent with an embodiment of the invention.

### DETAILED DESCRIPTION

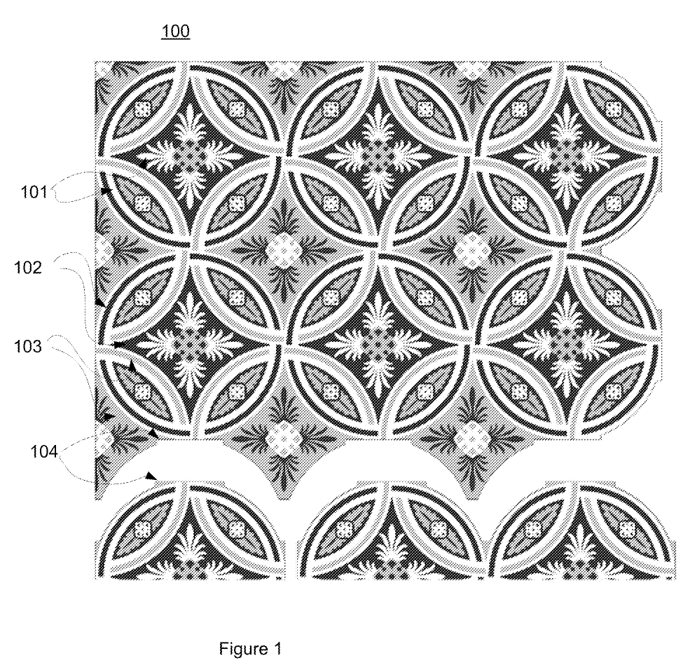

FIG. 1 is a representation of a stencil in an embodiment of the invention the stencil 100 consists of different colorant zones 101-103. Each of the colorant zones represents a different level of colorant. Exemplary “levels of colorant” are colors, combinations of colors, and lightness or darkness. Gray scale level 101 is the lightest area, 102 is the darkest area and 103 is at an intermediate level of lightness/darkness. The areas 101, 102 and 103 are separately removable from the stencil sheet 100. The boundaries separating the areas 101, 102 and 103 are scored or otherwise perforated to allow separation or removal of one area without disturbing the other. The Stencil sheet is composed of an adhesive side (not shown) and a non-adhesive side. The adhesive side may be protected by a release sheet as is known in the art to allow convenient transport and protection of the adhesive coating prior to application of the stencil to the surface to be decorated. Stencils may be composed of sheets as shown 100. Larger patterned areas may be created by cutting and interlocking edges of neighboring sheets 104. Identification of the different colorant areas 101-103 may be done by shading of the areas on the stencil or by other indicia as examples are discussed below. A colorant is associated with each of the areas. Colorant 101 would be the lightest colorant and associated with the lightest area 101. The lightest area is a primary or un-mixed colorant area. Primary may, but here does not necessarily, refer to primary as in commonly accepted cyan, magenta and yellow or red, green and blue. Primary implies a colorant that when applied to the area to be decorated does not have its color or level mixed or affected by other areas. In the procedures to follow area 101 would be the first applied area and applied prior to placing the stencil over the area to be decorated. The colorant associated with the area 102, for convenience here identified as colorant 102 would be the second applied colorant and first applied after application of the stencil to the area to be decorated. In a strict lightness-darkness shading regime colorant 102 would be the darkest of the applied colorants. Finally in this 3-color example the third colorant, colorant 103 would have an intermediary darkness between that of 101 and 102. In the sequence of use, the stencil areas protecting area 103 are removed after applying colorant 102 atop the stencil with the areas 102 removed to expose the surface to be decorated. Colorant 103 is applied and then the entire stencil is removed to reveal the finished decorated surface. The color of these darkest of areas 102 would be the color resulting from colorants 101, 102 and 103 applied in that sequence. The color of the lightest area 101 would be just due to the colorant 101. The color in the areas 103 would be the color resulting from the colorants 101 and 103 applied in that sequence. The terminology darkest in the sense of the invention implies those areas that are affected by the largest number of layers of colorant and the term lightest refers to those areas that are colored by the fewest number of layers of colorant. In one embodiment the colorants 101, 102 and 103 are wood stains. In another embodiment the colorants are at least partially transparent colorant. In another embodiment glazes are used as colorants. In yet another embodiment watercolors are colorants. Addition of a second colorant in a layer on top of the first results in a new color that is the sum of the color of the two applied in that order. The selection of colorants to be associated with each of the desired colored areas of the pattern is dependent upon not just the particular colorant, but also on the order of application. Applying a cyan colorant over the top of yellow results in a different shade of green than addition of a yellow colorant over the top of a cyan. In another embodiment the colorants may not be traditional colorants at all but other coating substances, which result in a distinguishable color or other visualization by application in a sequence. As a non-limiting example “colorant” 3 may be bleach that lightens rather than darkens the previously coated areas. In another embodiment colorant 3 may be a varnish that results in areas that are differentiated by level of gloss. In another embodiment colorant 2 may be a decorative pigment or other particulate or embedded decorative elements that produces a distinguishable visual effect by virtue of being encapsulated between colorants 1 and 3. Other examples of effects of multiple levels of colorants are limited only by imagination and experimentation. The invention provides means of generating complex patterns upon a surface through design of a stencil pattern and a sequential application of coatings applied in broad swaths to the area. Fine line, detailed, multi-chromatic decorations may be created on a surface without the need for the skill to paint, draw or otherwise create fine lines.

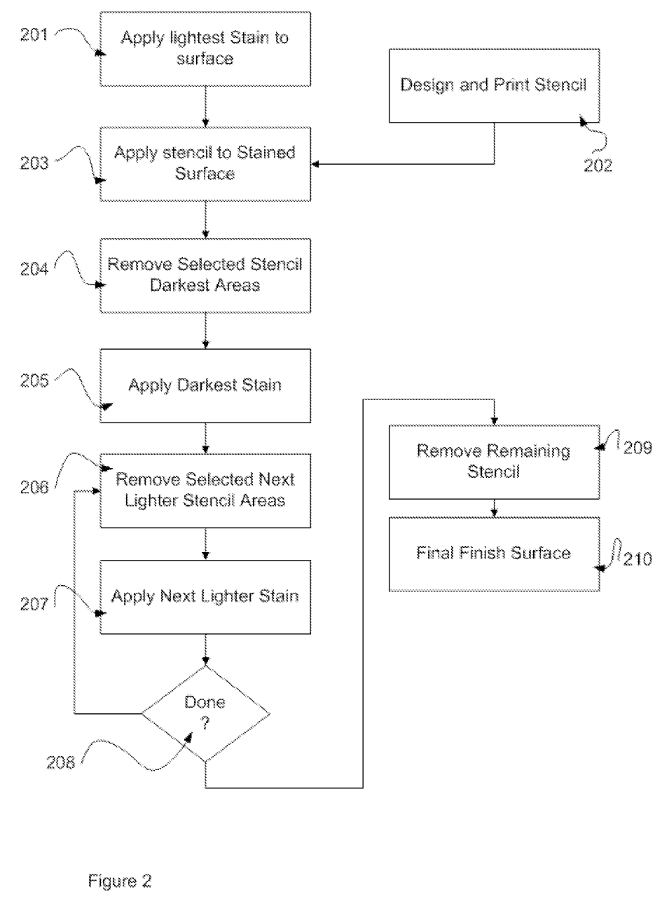

The general sequence of steps for sequential application of coatings in an embodiment of the invention is diagrammed in FIG. 2. The description for ease of communication is for application of a stain to a wood surface. However those skilled in the art will see that the same steps would apply to other colorants to other surfaces and is quite general for sequential application for sequential applications of coatings that affect the visual appearance by their sequential application.

The sequence of application is first the lightest colorant, then after application of the stencil over the lightest element, the darkest colorant is applied, followed by in order the remaining colorants in order of darkest to lightest. After design of the stencil and selection of colorants, both steps discussed in more detail below, a first selected lightest stain is applied to the surface to be decorated 201. The stencil is then applied over this coated surface 203 and areas of the stencil corresponding to the darkest or most heavily coated region are removed 204 and the darkest stain or coloration is applied 205. Selected sections of the stencil are then removed 206 and the next lightest colorant is applied 207. This sequence of stencil removal and application of the next lightest colorant is repeated until all colorants have been applied 208. Any remaining stencil elements are then removed, 209 and optionally a final surface finish may be applied to the entire now decorated surface 210.

In another embodiment, the colorants used are not stains but rather any colorant whose sequential application produces a series of different visual appearance. As non-limiting examples, the colorants might be transparent stains, watercolors, or, inks. The sequence of application is chosen based upon the desired end color set and the either empirically or otherwise known effects of the “summation” of the colors. As a non-limiting example for explanation four colorants are selected as white, cyan, magenta, and yellow and the order of application is white, cyan, magenta and finally yellow. The flow chart of FIG. 2 is followed except the sequence is as defined. The appropriately designed stencil would then produce a multi-colored design. Areas may be white, black, red and yellow. The possible combinations and resulting colors are enumerated in Table 1.

TABLE 1
An embodiment using White, Cyan, Magenta and Yellow colorants.

| 1^{st} colorant | 2^{nd} colorant | 3^{rd} colorant | 4^{th} colorant | Result |
|---|---|---|---|---|
| White | None | None | None | White |
| White | Cyan | Magenta | Yellow | Black |
| White | None | Magenta | Yellow | Red |
| White | None | None | Yellow | Yellow |

It would be apparent to those skilled in the art that selection of different ordering of application or a different colorant set would provide a wide spectrum of final colors and designs. A selection set may result in for example a gray color rather than black in the second line set depending upon the intensity of the cyan, magenta and yellow colorants. In each case the application process generally described by FIG. 2 requires only removal of sections of the stencil after each colorant application. Colorants are applied in broad application swaths over the area to be decorated. Fine detail painting skill is not required yet a multicolored and detailed design pattern results.

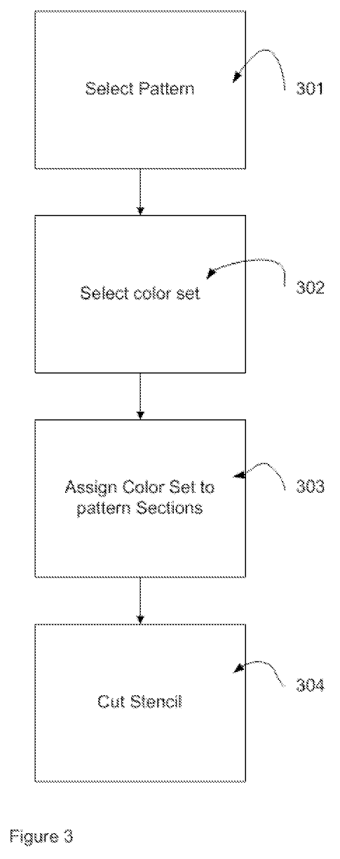

Another embodiment provides a stencil suitable for use in the application process. FIG. 3 depicts a block diagram of the stencil design process. A pattern is selected 301 to be used for the decorated surface. The pattern may have multiple detailed regions for which particular color sets are desired. The color set for the pattern is then selected 302. The color set is selected from a known or empirically determined set that would provide the desired final colors from sequential application as described above. The color set may be stains of varying darkness, colorants or pigments through which successive applications result in successively darker areas. The number of colorants may generally in the approximate range of 2 to 10 with an optimal range found to be about 5. The colorant set is then assigned to the patterned sections of the design 303. A first colorant is selected that to be applied under the entire design. The second colorant is selected to be applied after applying the stencil and removing selected sections of the stencil. Each colorant would be associated with section(s) of the stencil design to be removed prior to application of that colorant. The Stencil is then cut 304 and optionally labeled with appropriate indicia to allow application of the colorants following the procedures already discussed. The process of designing and preparing the stencil is most often done using computerized systems known in the art. Computer programs are available to create original designs or to capture designs that may come from other files such as image files. Boundaries between sections are identified and the design computer is interfaced to a plotter device that can provided scoring or perforations of the section boundaries for removal at the appropriate point in the process.

The stencil material is known in the art and is generally adhesive backed flexible film or paper or other material selected for compatibility with both the coatings to be used during decoration and the surface to be decorated. The stencil material must not be soluble in the decorative coating material and must not adhere so strongly to the surface to be decorated that the surface is damaged during the removal process. The stencil material is often composed of the stencil film, a top layer transfer tape to hold the stencil together during transport and application, an adhesive backing suitable for attaching the stencil to the surface to be decorated and a removable liner to protect the adhesive layer during preparation and transport of the stencil. In typical use the liner is removed just prior to attachment of the stencil to the surface to be decorated via the adhesive layer. The transfer tape is removed after the stencil has been adhesively attached to the surface to be decorated.

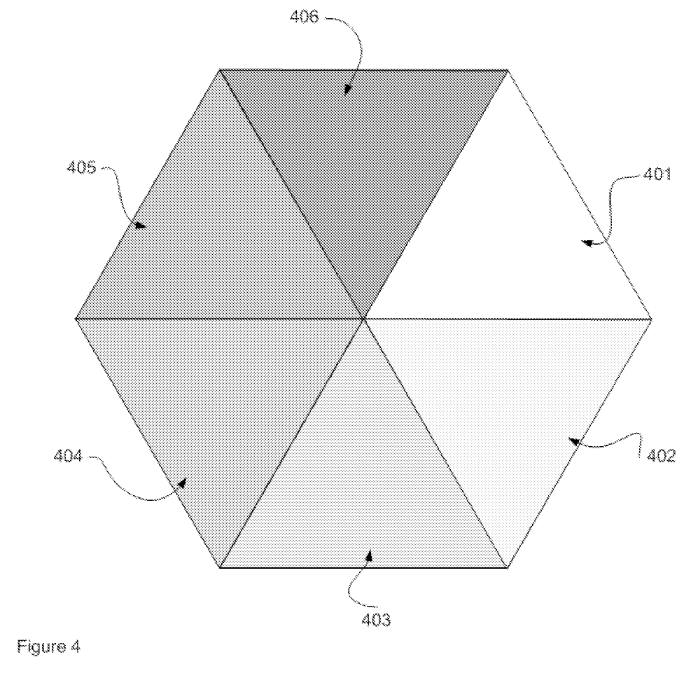

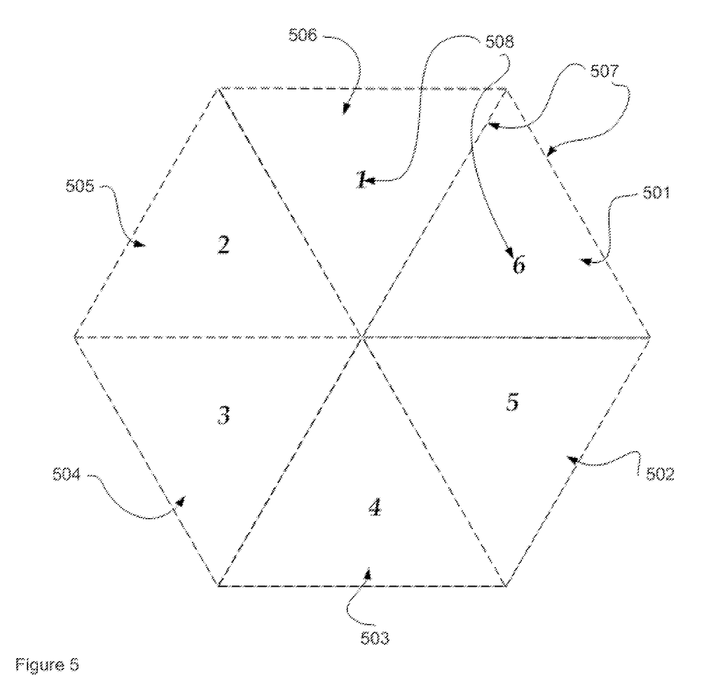

In an embodiment exemplified in FIG. 4 a design is made with 6 color regions. The regions may be differentiated as discussed above by color, gray scale tone or any other visual attributes that result from successive application of coatings. In the particular embodiment shown if the differentiation were strictly degree of lightness, region 401 is the lightest region and would be applied first followed by application of a stencil and then application of colorants associated with region 406 and then the colorants associated with the remaining regions in the order of 405, 404, 403 and 402. A stencil embodiment consistent with the pattern design of FIG. 4 is depicted in FIG. 5. The stencil consists of regions 501-506 corresponding to each of the regions of the design pattern 401-406 of FIG. 4. The regions are separated by scored or perforated boundaries 507 that allow removal of the individual sections 501-506 before and after application of selected colorant coatings associated with each of the regions. In another embodiment optional indicia 508 are included to identify sections and the order for removal during the coating process already described. Indicia may be numbers, letters other symbols or even coloration of the stencil.

In another embodiment a kit is provided that contains tools and instructions necessary to carry out the previously described process. In one embodiment the kit is for the preparation of faux marquetry through use of stains on wood or similar satin accepting surfaces.

### EXAMPLE

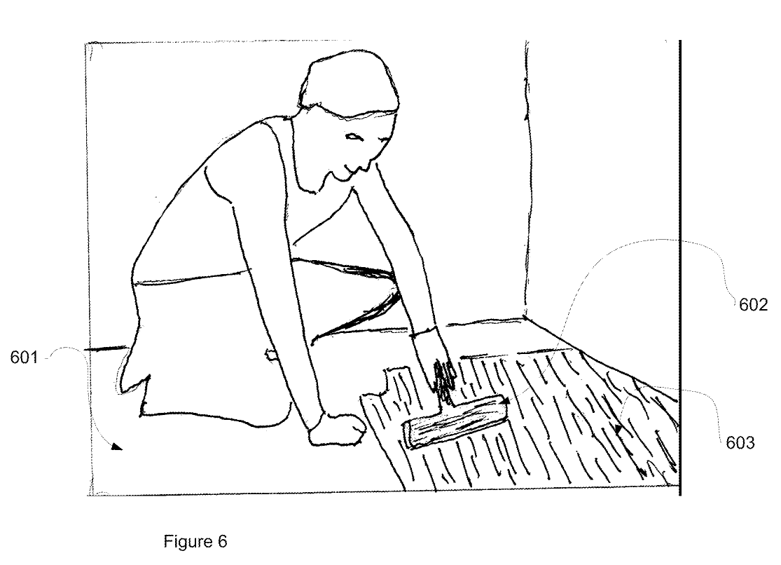

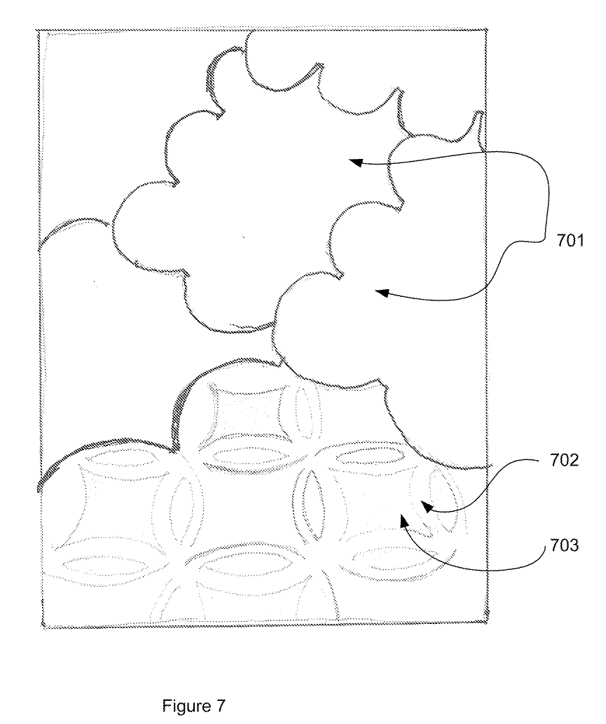

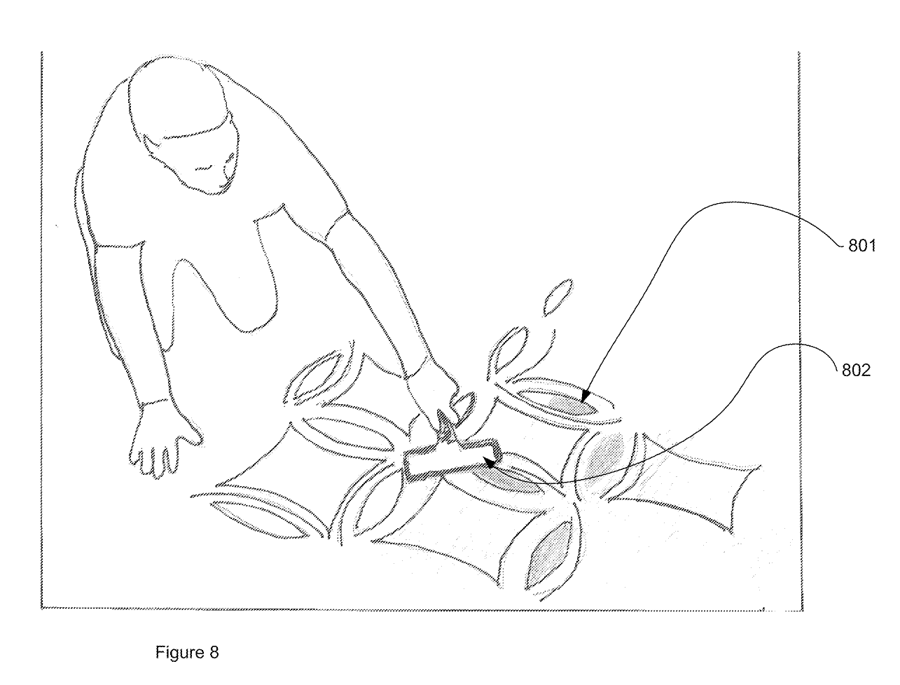

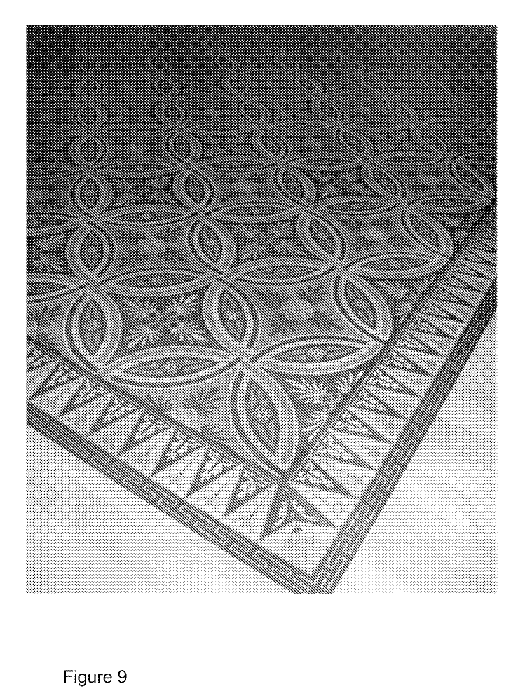

FIGS. 6 through 10 show an example of application of the materials and processes to the creation of a faux marquetry pattern on a floor. A bare wood floor was prepared for finishing by methods known in the art of sanding preparing a surface 601 ready to accept a stain. The stain is applied using techniques known in the art such as the applicator shown 602 to produce a stained area 603. The first stain so selected is the lightest of the three colorant stains selected for the project. A design was selected and stencil prepared (not shown). The stencil was then applied to the now stained floor as shown in FIG. 7. Individual sheets of the stencil 701 are cut and fit together to provide a continuously coated surface. Selected regions of the stencil are then removed exposing regions 703 to accept the next application of stain, while protecting regions 702 during the next application. The staining process is then repeated as shown in FIG. 8. The same broad-brush type application tool 802 is used to apply stain to selected regions uncovered by the stencil 801. The process of removing regions and stain is repeated until all the stains for the pattern have been applied. After the final application all remaining stencil elements are removed and optionally a final surface finish is applied resulting in a faux marquetry pattern as shown in FIG. 9.

### CONCLUSIONS

A surface decoration system is described. The system includes materials and processes that enable detailed multiple color and hue patterns to be placed upon a surface without the need for abilities to paint fine detail. Successive coating layers are applied with a broad-brush applicator. The process may be used for colors, gray scale, stain and any other optical effect that may be effected through sequential application of coatings. An example shows application of the technique to a faux marquetry flooring design.

I claim:

1. A surface decoration system comprising:
a) a means to design a stencil,
b) a means to apply the stencil to a surface to be decorated, and,
c) a means to sequentially apply a plurality of colorants to the stencil covered surface.

2. The system of claim 1 wherein the plurality of colorants are wood stains.

3. The system of claim 1 wherein the plurality of colorants are watercolors.

4. The system of claim 1 wherein the plurality of colorants are inks.

5. The system of claim 1 wherein the plurality of colorants are glazes.

6. A process to decorate a surface with a plurality of coating materials comprising:
a) applying a first of the coating materials to the surface,
b) applying an adhesive backed stencil comprised of a plurality of sections each defined by a separable boundary to the surface,
c) sequentially, removing at least one of the sections of the stencil and applying another of the plurality of coating materials to the surface,
d) removing the stencil, and
e) optionally adding another finish coating to the surface.

7. The process of claim 6 wherein the plurality of coating materials are wood stains.

8. The process of claim 6 wherein the plurality of coating material are watercolors.

9. The process of claim 6 wherein the plurality of coating materials are inks.

10. The process of claim 6 wherein the plurality of coating materials are glazes.

11. The process of claim 6 wherein the plurality of coating materials include any colorant wherein the color may be modified by successive additions of other colorants.

12. The process of claim 6 wherein at least one of the plurality of coating materials changes the gloss of the surface.

13. The process of claim 6 wherein at least one of the coating materials includes embedded decorative elements.

14. A decorated surface on which a design has been applied by successive sequential applications of colorant to areas of the surface defined by openings in a stencil.

15. The decorated surface of claim 14 wherein the design is a faux marquetry.

16. A stencil to aid in the decoration of a surface by sequential applications of colorants wherein sections of the stencil are to be removed between the sequential applications of colorants.

17. The stencil of claim 16 wherein the order of removal of the sections of the stencil is indicated by imprinted indicia.

18. A kit for preparation of a decorated surface comprising:
a) a stencil design,
b) a plurality of colorants,
c) an applicator tool, and
d) instructions for sequential application of the colorants interspersed with removal of portions of the stencil design.

19. The kit of claim 18 wherein the kit is for the preparation of a faux marquetry design.
